(19) United States
(12) Patent Application Publication
(10) Pub. No.: US 2018/0234891 A1
(43) Pub. Date: Aug. 16, 2018

(54) Data Transmission Method, Method for Accessing Network, Related Device, and System

(71) Applicant: Huawei Technologies Co., Ltd., Shenzhen (CN)

(72) Inventors: Hui JIN, Beijing (CN); Xiaoyan DUAN, Beijing (CN)

(73) Assignee: Huawei Technologies Co., Ltd.

(21) Appl. No.: 15/751,064

(22) PCT Filed: Aug. 7, 2015
(86) PCT No.: PCT/CN2015/086371

§ 371 Date: Feb. 7, 2018

(51) Int. Cl. H04W 36/00; H04W 28/02

(52) U.S. Cl. CPC H04W 36/0011; H04W 28/0263; H04W 36/0055

(57) ABSTRACT

A data transmission method in order to ensure, from a time when a wearable device (WD) accesses a network using a mobile terminal to a time when the WD moves away from the mobile terminal, continuity of a related service of the WD, where the method includes receiving, by a core network entity, a first message from first user equipment (UE), where the first message is used by the first UE to request to change from accessing a network using second UE to directly accessing the network, and setting up, by the core network entity, a target bearer on the first UE such that the first UE transmits data using the target bearer.

### CROSS-REFERENCE TO RELATED APPLICATION

This application is a U.S. National Stage of International Patent Application No. PCT/CN2015/086371 filed on Aug. 7, 2015, which is hereby incorporated by reference in its entirety.

### TECHNICAL FIELD

The present disclosure relates to the communications field, and in particular, to a data transmission method, a method for accessing a network, a related device, and a system.

### BACKGROUND

With rapid development of technologies, wearable devices (WDs) appear in people's life. Directly connecting a WD to a network will be a development tendency in future. However, because a WD has a small battery capacity, when the WD directly performs network communication with a base station, rapid battery consumption and a short standby time are caused. In addition, the WD has a special shape, resulting in difficult antenna design. At present, only single-antenna design can be implemented, and only data of a same quantity can be sent. Compared with multiple antennas, more time needs to be spent, and lots of network resources need to be consumed.

Usually, there is a high-performance mobile terminal around a WD. The mobile terminal and the WD separately perform network communication, and no resultant force is formed. Therefore, by connecting the WD to a network using the mobile terminal, a quantity of electricity of the WD can be saved, and transmission efficiency of the WD can be improved.

At present, a WD may access a network using a mobile terminal, to perform a related service of the WD. However, after the WD accesses the network using the mobile terminal, when the WD subsequently moves away from the mobile terminal, communication interruption may occur. Consequently, continuity of the related service of the WD cannot be ensured.

### SUMMARY

Embodiments of the present disclosure provide a data transmission method, a method for accessing a network, a related device, and a system in order to ensure, from a time when a WD accesses a network using a mobile terminal to a time when the WD moves away from the mobile terminal, continuity of a related service of the WD.

A first aspect of the present disclosure provides a data transmission method, including receiving, by a core network entity, a first message sent by first user equipment (UE), where the first message is used by the first UE to request to change from accessing a network using second UE to directly accessing the network, and setting up, by the core network entity, a target bearer on the first UE such that the first UE transmits data using the target bearer.

With reference to the first aspect, in a first possible implementation, setting up, by the core network entity, a target bearer on the first UE includes obtaining, by the core network entity, bearer context of the first UE, and setting up, by the core network entity, the target bearer on the first UE according to the bearer context of the first UE.

With reference to the first possible implementation of the first aspect, in a second possible implementation, setting up, by the core network entity, the target bearer on the first UE according to the bearer context of the first UE includes sending, by the core network entity, a second message to a base station such that the base station sends a third message to the first UE, and sends a fourth message to the core network entity, and receiving, by the core network entity, the fourth message in order to set up a bearer between the first UE and a gateway.

With reference to any one of the first aspect or the first and the second possible implementations of the first aspect, in a third possible implementation, after setting up, by the core network entity, a target bearer on the first UE, the method further includes obtaining, by the core network entity, the bearer context of the first UE, where the bearer context of the first UE saves a mapping relationship between a first evolved packet system (EPS) bearer identity (EBI) corresponding to the target bearer on the first UE and a second EBI of the second UE, and obtaining, by the core network entity, the second EBI of the second UE according to the mapping relationship, and sending a fifth message to the base station such that the base station sends a sixth message to the second UE to delete a bearer corresponding to the second EBI of the second UE.

With reference to the third possible implementation of the first aspect, in a fourth possible implementation, after deleting a bearer corresponding to the second EBI of the second UE, the method further includes deleting, by the core network entity, the mapping relationship between the first EBI and the second EBI in the bearer context of the first UE.

With reference to any one of the first aspect or the first to the fourth possible implementations of the first aspect, in a fifth possible implementation, the first message includes path change indication information.

With reference to any one of the first aspect or the first to the fifth possible implementations of the first aspect, in a sixth possible implementation, the first message is a tracking area update (TAU) message.

A second aspect of the present disclosure provides a data transmission method, including sending, by first UE, a first message to a core network entity such that the core network entity sets up a target bearer on the first UE, where the first message is used by the first UE to request to change from accessing a network using second UE to directly accessing the network, and transmitting, by the first UE, data using the target bearer.

With reference to the second aspect, in a first possible implementation, before sending, by first UE, a first message to a core network entity, the method further includes sending, by the first UE, a seventh message to the second UE, where the seventh message is used to request the second UE to send network information to the first UE, receiving, by the first UE, the network information sent by the second UE, and accessing, by the first UE, the network using the network information.

With reference to the first possible implementation of the second aspect, in a second possible implementation, the network information includes at least one of a globally unique temporary UE identity (GUTI) of the first UE, an access frequency of a cell on which the second UE currently camps, a physical cell identity (PCI) of a cell on which the second UE currently camps, or a system information block (SIB) of a cell on which the second UE currently camps.

With reference to the first possible implementation of the second aspect, in a third possible implementation, before transmitting, by the first UE, data using the target bearer, the method further includes modifying, by the first UE, a mapping target of an uplink traffic flow template (TFT) from a device to device bearer identity (DBI) to a first EBI corresponding to the target bearer on the first UE.

With reference to the third possible implementation of the second aspect, in a fourth possible implementation, after modifying, by the first UE, a mapping target of an uplink TFT from a DBI to a first EBI corresponding to the target bearer on the first UE, the method further includes deleting, by the first UE, a mapping relationship between the DBI and the first EBI.

With reference to any one of the second aspect or the first to the fourth possible implementations of the second aspect, in a fifth possible implementation, the first message includes path change indication information.

With reference to any one of the second aspect or the first to the fifth possible implementations of the second aspect, in a sixth possible implementation, the first message is a TAU message.

A third aspect of the present disclosure provides a method for accessing a network, including receiving, by a core network entity, a first message, where the first message is used to request the core network entity to change a current communication path of the first UE, and changing, by the core network entity, the current communication path of the first UE to a new communication path such that the first UE accesses a network using the new communication path.

With reference to the third aspect, in a first possible implementation, receiving, by a core network entity, a first message includes receiving, by the core network entity, the first message sent by the second UE, where the first message includes an identity of the first UE.

With reference to the third aspect, in a second possible implementation, receiving, by a core network entity, a first message includes receiving, by the core network entity, the first message that is sent by the first UE using the second UE, where the first message includes an identity of the first UE and an evolved universal mobile telecommunications system (UMTS) terrestrial radio access network (E-UTRAN) cell global identifier (ECGI) of a target cell that is detected by the first UE.

With reference to the third aspect, in a third possible implementation, changing, by the core network entity, the current communication path of the first UE to a new communication path includes sending, by the core network entity, a second message to a first base station such that the first base station generates a target to source transparent container, and sends the target to source transparent container to the core network entity using a third message, where the first base station is a base station serving the second UE, and changing, by the core network entity, the current communication path of the first UE to the new communication path according to the target to source transparent container.

With reference to the third aspect, in a fourth possible implementation, changing, by the core network entity, the current communication path of the first UE to a new communication path includes obtaining, by the core network entity, a second base station, where the second base station is a base station corresponding to the ECGI, sending, by the core network entity, a fourth message to the first base station such that the first base station sends a fifth message to the core network entity, sending, by the core network entity, a second message to the second base station such that the second base station generates a target to source transparent container, and sends the target to source transparent container to the core network entity using a third message, and changing, by the core network entity, the current communication path of the first UE to the new communication path according to the target to source transparent container.

With reference to the third possible implementation of the third aspect, in a fifth possible implementation, sending, by the core network entity, a second message to a first base station such that the first base station generates a target to source transparent container includes obtaining, by the core network entity, a first evolved packet system bearer identity EBI, where the first EBI is an EBI of the first UE, obtaining, by the core network entity, a second EBI of the second UE according to the first EBI of the first UE, and adding, by the core network entity, the second EBI to the second message such that the first base station generates the target to source transparent container according to the second EBI.

With reference to the fourth possible implementation of the third aspect, in a sixth possible implementation, sending, by the core network entity, a second message to the second base station such that the second base station generates a target to source transparent container includes obtaining, by the core network entity, a first EBI, where the first EBI is an EBI of the first UE, obtaining, by the core network entity, a second EBI of the second UE according to the first EBI of the first UE, adding, by the core network entity, the second EBI to the fourth message such that the first base station generates a source to target transparent container according to the second EBI, and sends the source to target transparent container to the core network entity using the fifth message, and adding, by the core network entity, the source to target transparent container to the second message such that the second base station generates the target to source transparent container according to the source to target transparent container.

With reference to the third aspect, in a seventh possible implementation, after changing, by the core network entity, the current communication path of the first UE to a new communication path, the method further includes obtaining, by the core network entity, bearer context of the first UE, where the bearer context of the first UE saves a mapping relationship between the first EBI corresponding to the target bearer of the first UE and the second EBI of the second UE, and obtaining, by the core network entity, the second EBI of the second UE according to the mapping relationship, and sending a sixth message to the first base station such that the first base station sends a seventh message to the second UE, to delete a bearer corresponding to the second EBI of the second UE.

With reference to the seventh possible implementation of the third aspect, in an eighth possible implementation, after deleting a bearer corresponding to the second EBI of the second UE, the method further includes deleting, by the core network entity, the mapping relationship between the first EBI of the first UE and the second EBI of the second UE in the bearer context of the first UE.

A fourth aspect of the present disclosure provides a method for accessing a network, including obtaining, by first UE, a new communication path, and changing, by a core network entity, a current communication path of the first UE to the new communication path, and accessing, by the first UE, a network according to the new communication path.

With reference to the fourth aspect, in a first possible implementation, before obtaining, by first UE, a new communication path, the method further includes obtaining, by the first UE, network information from the second UE, obtaining, by the first UE according to the network information, an ECGI of a target cell that is detected by the first UE, and sending, by the first UE, a first message to the second UE such that the second UE sends the first message to the core network entity.

With reference to the first possible implementation of the fourth aspect, in a second possible implementation, the network information includes at least one of a GUTI of the first UE, an access frequency of a cell on which the second UE currently camps, a PCI of a cell on which the second UE currently camps, or an SIB of a cell on which the second UE currently camps.

With reference to the fourth aspect, in a third possible implementation, after accessing, by the first UE, a network according to the new communication path, the method further includes modifying, by the first UE, a mapping target of an uplink TFT from a DBI to a first EBI corresponding to the target bearer on the first UE.

With reference to the third possible implementation of the fourth aspect, in a fourth possible implementation, after modifying, by the first UE, a mapping target of an uplink TFT from a DBI to a first EBI corresponding to the target bearer on the first UE, the method further includes deleting, by the first UE, a mapping relationship between the DBI and the first EBI.

A fifth aspect of the present disclosure provides a data transmission apparatus, including a receiving module configured to receive a first message sent by first UE, where the first message is used by the first UE to request to change from accessing a network using second UE to directly accessing the network, and a setup module configured to set up a target bearer on the first UE such that the first UE transmits data using the target bearer.

With reference to the fifth aspect, in a first possible implementation, the setup module is further configured to obtain bearer context of the first UE, and set up the target bearer on the first UE according to the bearer context of the first UE.

With reference to the first possible implementation of the fifth aspect, in a second possible implementation, the setup module is further configured to send a second message to a base station such that the base station sends a third message to the first UE, and sends a fourth message to the core network entity, and receive the fourth message in order to set up a bearer between the first UE and a gateway.

With reference to any one of the fifth aspect or the first and the second possible implementations of the fifth aspect, in a third possible implementation, the data transmission apparatus further includes an obtaining module configured to obtain the bearer context of the first UE, where the bearer context of the first UE saves a mapping relationship between a first EBI corresponding to the target bearer on the first UE and a second EBI of the second UE, where the obtaining module is further configured to obtain the second EBI of the second UE according to the mapping relationship, and a sending module configured to send a fifth message to the base station such that the base station sends a sixth message to the second UE, to delete a bearer corresponding to the second EBI of the second UE.

With reference to the third possible implementation of the fifth aspect, in a fourth possible implementation, the data transmission apparatus further includes a deletion module configured to delete the mapping relationship between the first EBI and the second EBI in the bearer context of the first UE.

With reference to any one of the fifth aspect or the first to the fourth possible implementations of the fifth aspect, in a fifth possible implementation, the first message includes path change indication information.

With reference to any one of the fifth aspect or the first to the fifth possible implementations of the fifth aspect, in a sixth possible implementation, the first message is a TAU message.

A sixth aspect of the present disclosure provides a data transmission apparatus, including a sending module configured to send a first message to a core network entity such that the core network entity sets up a target bearer on the first UE, where the first message is used by the first UE to request to change from accessing a network using second UE to directly accessing the network, and a data transmission module configured to transmit data using the target bearer.

With reference to the sixth aspect, in a first possible implementation, the data transmission apparatus further includes the sending module, further configured to send a seventh message to the second UE before sending the first message to the core network entity, where the seventh message is used to request the second UE to send network information to the first UE, a receiving module configured to receive the network information sent by the second UE, and a network accessing module configured to access the network using the network information.

With reference to the first possible implementation of the sixth aspect, in a second possible implementation, the network information includes at least one of a GUTI of the first UE, an access frequency of a cell on which the second UE currently camps, a PCI of a cell on which the second UE currently camps, or an SIB of a cell on which the second UE currently camps.

With reference to the first possible implementation of the sixth aspect, in a third possible implementation, the data transmission apparatus further includes a modification module configured to modify a mapping target of an uplink TFT from a DBI to a first EBI corresponding to the target bearer on the first UE before the data transmission module transmits the data using the target bearer.

With reference to the third possible implementation of the sixth aspect, in a fourth possible implementation, the data transmission apparatus further includes a deletion module configured to delete a mapping relationship between the DBI and the first EBI after the mapping target of the uplink TFT is modified from the DBI to the first EBI corresponding to the target bearer on the first UE.

With reference to any one of the sixth aspect or the first to the fourth possible implementations of the sixth aspect, in a fifth possible implementation, the first message includes path change indication information.

With reference to any one of the sixth aspect or the first to the fifth possible implementations of the sixth aspect, in a sixth possible implementation, the first message is a TAU message.

A seventh aspect of the present disclosure provides an apparatus for accessing a network, including a receiving module configured to receive a first message, where the first message is used to request a core network entity to change a current communication path of the first UE, and a change module configured to change the current communication path of the first UE to a new communication path such that the first UE accesses a network using the new communication path.

With reference to the seventh aspect, in a first possible implementation, the receiving module is further configured to receive the first message sent by the second UE, where the first message includes an identity of the first UE.

With reference to the seventh aspect, in a second possible implementation, the receiving module is further configured to receive the first message that is sent by the first UE using the second UE, where the first message includes an identity of the first UE and an ECGI of a target cell that is detected by the first UE.

With reference to the seventh aspect, in a third possible implementation, the change module is further configured to send a second message to a first base station such that the first base station generates a target to source transparent container, and sends the target to source transparent container to the core network entity using a third message, where the first base station is a base station serving the second UE, and change the current communication path of the first UE to the new communication path according to the target to source transparent container.

With reference to the seventh aspect, in a fourth possible implementation, the change module is further configured to obtain a second base station, where the second base station is a base station corresponding to the ECGI, send a fourth message to the first base station such that the first base station sends a fifth message to the core network entity, send a second message to the second base station such that the second base station generates a target to source transparent container, and sends the target to source transparent container to the core network entity using a third message, and change the current communication path of the first UE to the new communication path according to the target to source transparent container.

With reference to the third possible implementation of the seventh aspect, in a fifth possible implementation, the change module is further configured to obtain a first evolved packet system bearer identity EBI, where the first EBI is an EBI of the first UE, obtain a second EBI of the second UE according to the first EBI of the first UE, and add the second EBI to the second message such that the first base station generates the target to source transparent container according to the second EBI.

With reference to the fourth possible implementation of the seventh aspect, in a sixth possible implementation, the change module is further configured to obtain a first EBI, where the first EBI is an EBI of the first UE, obtain a second EBI of the second UE according to the first EBI of the first UE, add the second EBI to the fourth message such that the first base station generates a source to target transparent container according to the second EBI, and sends the source to target transparent container to the core network entity using the fifth message, and add the source to target transparent container to the second message such that the second base station generates the target to source transparent container according to the source to target transparent container.

With reference to the fifth or the sixth possible implementation of the seventh aspect, in a seventh possible implementation, the apparatus further includes an obtaining module configured to obtain bearer context of the first UE after the change module changes the current communication path of the first UE to the new communication path, where the bearer context of the first UE saves a mapping relationship between the first EBI corresponding to the target bearer of the first UE and the second EBI of the second UE, where the obtaining module is further configured to obtain the second EBI of the second UE according to the mapping relationship, and send a sixth message to the first base station such that the first base station sends a seventh message to the second UE to delete a bearer corresponding to the second EBI of the second UE.

With reference to the seventh possible implementation of the seventh aspect, in an eighth possible implementation, the apparatus further includes a deletion module configured to delete the mapping relationship between the first EBI of the first UE and the second EBI of the second UE in the bearer context of the first UE.

An eighth aspect of the present disclosure provides an apparatus for accessing a network, including an obtaining module configured to obtain a new communication path, where a core network entity changes a current communication path of the first UE to the new communication path, and a network accessing module configured to access a network according to the new communication path.

With reference to the eighth aspect, in a first possible implementation, the apparatus further includes the obtaining module, further configured to obtain network information from the second UE, the obtaining module, further configured to obtain, according to the network information, an ECGI of a target cell that is detected by the first UE, and a sending module configured to send a first message to the second UE such that the second UE sends the first message to the core network entity.

With reference to the first possible implementation of the eighth aspect, in a second possible implementation, the network information includes at least one of the following content a GUTI of the first UE, an access frequency of a cell on which the second UE currently camps, a PCI of a cell on which the second UE currently camps, or an SIB of a cell on which the second UE currently camps.

With reference to the eighth aspect, in a third possible implementation, the apparatus further includes a modification module configured to modify a mapping target of an uplink TFT from a DBI to a first EBI corresponding to the target bearer on the first UE after the network accessing module accesses the network according to the new communication path.

With reference to the third possible implementation of the eighth aspect, in a fourth possible implementation, the apparatus further includes a deletion module configured to delete, by the first UE, a mapping relationship between the DBI and the first EBI after the modification module modifies the mapping target of the uplink TFT from the DBI to the first EBI corresponding to the target bearer on the first UE.

By means of the foregoing technical solutions, a core network entity receives a first message sent by first UE, where the first message is used by the first UE to request to change from accessing a network using second UE to directly accessing the network, and the core network entity sets up a target bearer on the first UE such that the first UE transmits data using the target bearer. Communication is not interrupted in order to ensure continuity of a related service of the first UE.

### BRIEF DESCRIPTION OF DRAWINGS

FIG. 1 is a schematic flowchart of a data transmission method according to an embodiment of the present disclosure;

FIG. 2 is another schematic flowchart of a data transmission method according to an embodiment of the present disclosure;

FIG. 3 is a schematic flowchart of a method for accessing a network according to an embodiment of the present disclosure;

FIG. 4 is another schematic flowchart of a method for accessing a network according to an embodiment of the present disclosure;

FIG. 5 is another schematic flowchart of a data transmission method according to an embodiment of the present disclosure;

FIG. 6 is another schematic flowchart of a method for accessing a network according to an embodiment of the present disclosure;

FIG. 7 is another schematic flowchart of a method for accessing a network according to an embodiment of the present disclosure;

FIG. 8 is a schematic structural diagram of a data transmission apparatus according to an embodiment of the present disclosure;

FIG. 9 is another schematic structural diagram of a data transmission apparatus according to an embodiment of the present disclosure;

FIG. 10 is a schematic structural diagram of an apparatus for accessing a network according to an embodiment of the present disclosure; and

FIG. 11 is another schematic structural diagram of an apparatus for accessing a network according to an embodiment of the present disclosure.

### DESCRIPTION OF EMBODIMENTS

Embodiments of the present disclosure provide a data transmission method, a method for accessing a network, a related device, and a system in order to ensure, from a time when a WD accesses a network using a mobile terminal to a time when the WD moves away from the mobile terminal, continuity of a related service of the WD.

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person skilled in the art based on the embodiments of the present disclosure without creative efforts shall fall within the protection scope of the present disclosure.

In the specification, claims, and accompanying drawings of the present disclosure, the terms “first,” “second,” “third,” “fourth,” and so on are intended to distinguish between different objects but do not indicate a particular order. In addition, the terms “including,” “including,” or any other variant thereof, are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

The technical solutions of the present disclosure may be applied to various communications systems, such as a Global System for Mobile Communications (GSM), a Code Division Multiple Access (CDMA) system, Wideband CDMA (WCDMA), a general packet radio service (GPRS), and Long Term Evolution (LTE).

First, it is noted that a core network entity mentioned in the embodiments of the present disclosure refers to an entity that can implement a mobility management logic function of UE. The core network entity may have different names, locations, and product forms in different networks.

For example, the core network entity mentioned in the embodiments of the present disclosure may refer to a mobile management entity (MME) connected to an E-UTRAN, a serving GPRS support node (SGSN) connected to a UTRAN/a GSM enhanced data rates for GSM evolution (EDGE) radio access network (GERAN), an access gateway (AGW) in a non-3rd Generation Partnership Project (3GPP) network, an entity having a mobile management logic function of an evolved packet data gateway (EPDG) in a wireless local area network (WLAN), an access service network gateway (ASNGW) in a Worldwide Interoperability for Microwave Access (WIMAX) network, an entity having an access mobile management logic function of a high rate packet data access network (HRPD-AN) in a WCDMA network, or an entity implementing mobile management logic function of UE in another network.

First UE may be a WD/wearable equipment (WE) or the like. The WD is a portable device that is directly body-worn or that is integrated into clothes or an accessory of a user. The WD, for example, a smart watch, a smart wrist strap, or smart glasses, is not only a hardware device, but also implements a powerful function by means of software support, data exchange, or cloud interaction. This is not limited in the present disclosure.

Second UE may be a mobile terminal, mobile UE, or the like, and may communicate with one or more core networks using a radio access network (RAN). The second UE may be a mobile terminal, for example, a mobile phone (or referred to as a “cellular” phone) or a computer having a mobile terminal. For example, the second UE may be a portable, pocket-sized, handheld, computer-built in, or in-vehicle mobile apparatus. The second UE exchanges a language and/or data with the RAN.

A first gateway may be a serving gateway (SGW), or the like.

A second gateway may be a packet data network gateway (PGW), or the like. The first gateway and the second gateway are gateways serving the first UE or are gateways serving the second UE. This is not limited in the present disclosure.

A base station may be a base transceiver station (BTS) in GSM or CDMA, or may be a NodeB (Node B) in WCDMA, or may be an evolved NodeB (eNB or e-Node B) in LTE. This is not limited in the present disclosure.

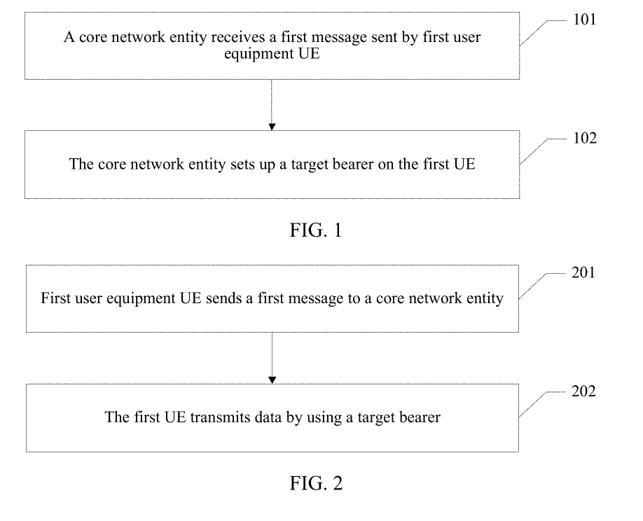

Referring to FIG. 1, an embodiment of a data transmission method in an embodiment of the present disclosure, which is an embodiment of a data transmission method on a core network entity side, includes receiving, by a core network entity, a first message sent by first UE, where the first message is used by the first UE to request to change from accessing a network using second UE to directly accessing the network, and setting up, by the core network entity, a target bearer on the first UE such that the first UE transmits data using the target bearer.

A specific process is as follows.

Step 101: The core network entity receives the first message sent by the first UE.

The first message includes path change indication information. The first message is a TAU message.

Step 102: The core network entity sets up the target bearer on the first UE.

The core network entity learns, according to the first message, that the first UE requests to change from accessing a network using second UE to directly accessing the network, and the core network entity sets up the target bearer on the first UE such that the first UE transmits data using the target bearer.

In some optional embodiments, setting up, by the core network entity, a target bearer on the first UE includes obtaining, by the core network entity, bearer context of the first UE, and setting up, by the core network entity, the target bearer on the first UE according to the bearer context of the first UE.

Further, setting up, by the core network entity, the target bearer on the first UE according to the bearer context of the first UE includes sending, by the core network entity, a second message to a base station such that the base station sends a third message to the first UE, and sends a fourth message to the core network entity, where the second message may be a bearer setup request message, the third message may be a radio bearer setup request (or Radio Resource Control (RRC) Connection Reconfiguration) message, the fourth message is a bearer setup response message, and certainly, the second message, the third message, and the fourth message may also be replaced by another message representing a same function, and this is not limited herein, and receiving, by the core network entity, the fourth message in order to set up a bearer between the first UE and a gateway.

In some optional embodiments, after setting up, by the core network entity, a target bearer on the first UE, the method further includes obtaining, by the core network entity, the bearer context of the first UE, where the bearer context of the first UE saves a mapping relationship between a first EBI corresponding to the target bearer on the first UE and a second EBI of the second UE, and obtaining, by the core network entity, the second EBI of the second UE according to the mapping relationship, and sending a fifth message to the base station such that the base station sends a sixth message to the second UE to delete a bearer corresponding to the second EBI of the second UE.

The fifth message is a deactivate bearer request message. The sixth message is an RRC connection reconfiguration message. Certainly, the fifth message and the sixth message may also be replaced by another message representing a same function. This is not limited herein.

Further, after deleting a bearer corresponding to the second EBI of the second UE, the method further includes deleting, by the core network entity, the mapping relationship between the first EBI and the second EBI in the bearer context of the first UE.

In this embodiment of the present disclosure, a core network entity receives a first message sent by first UE, where the first message is used by the first UE to request to change from accessing a network using second UE to directly accessing the network, and the core network entity sets up a target bearer on the first UE such that the first UE transmits data using the target bearer. Communication is not interrupted in order to ensure continuity of a related service of the first UE.

Based on the embodiment shown in FIG. 1, referring to FIG. 2, an embodiment of transmitting data on a UE side in an embodiment of the present disclosure includes sending, by first UE, a first message to a core network entity such that the core network entity sets up a target bearer on the first UE, where the first message is used by the first UE to request to change from accessing a network using second UE to directly accessing the network, and transmitting, by the first UE, data using the target bearer.

A specific process is as follows.

Step 201: The first UE sends the first message to the core network entity.

The first message includes path change indication information. The first message is a TAU message. The path change indication information is used to indicate that the first message is used to request to change a path, for example, change from a communication path for accessing a network using another UE to a communication path for directly accessing the network.

The first UE sends the first message to the core network entity such that the core network entity learns, according to the first message, that the first UE requests to change from accessing a network using second UE to directly accessing the network, and the core network entity sets up a target bearer on the first UE.

Step 202: The first UE transmits data using the target bearer.

The first UE transmits the data according to the target bearer set up by the core network entity in order to ensure continuity of a related service of the first UE.

For the first UE, a bearer (for example, an EPS bearer) for transmitting data includes two parts, a bearer between the first UE and a first gateway (for example, an SGW), and a bearer between the first gateway and a second gateway (for example, a PGW). The target bearer is a bearer between the first UE and the first gateway. In this solution, a communication path from the first UE to the first gateway is merely changed from connecting to the first gateway using the second UE to directly connecting to the first gateway, and the bearer between the first gateway and the second gateway remains unchanged. The second gateway is to assign an Internet Protocol (IP) address to the first UE. Therefore, in this solution, the second gateway is unchanged in order to ensure continuity of a service of the first UE.

In some optional embodiments, before sending, by first UE, a first message to a core network entity, the method further includes sending, by the first UE, a seventh message to the second UE, where the seventh message is used to request the second UE to send network information to the first UE, receiving, by the first UE, the network information sent by the second UE, and accessing, by the first UE, the network using the network information.

The seventh message is a network information request message.

The network information includes at least one of a GUTI of the first UE, an access frequency of a cell on which the second UE currently camps, a PCI of a cell on which the second UE currently camps, or an SIB of a cell on which the second UE currently camps.

It should be noted that the network information may be one type, or may be a combination of multiple types. Besides, in addition to the foregoing several types, the network information may be other content. This is not limited herein.

In some optional embodiments, before transmitting, by the first UE, data using the target bearer, the method further includes modifying, by the first UE, a mapping target of an uplink TFT from a DBI to a first EBI corresponding to the target bearer on the first UE. The DBI is an identity of a bearer directly used by the first UE and the second UE to transmit the data of the first UE. The DBI may also be replaced by another identity representing a same function, and this is not limited herein.

Further, after modifying, by the first UE, a mapping target of an uplink TFT from a DBI to a first EBI corresponding to the target bearer on the first UE, the method further includes deleting, by the first UE, a mapping relationship between the DBI and the first EBI.

In this embodiment of the present disclosure, first UE sends a first message to a core network entity such that the core network entity sets up a target bearer on the first UE, where the first message is used by the first UE to request to change from accessing a network using second UE to directly accessing the network, and the first UE transmits data using the target bearer. Communication is not interrupted in order to ensure continuity of a related service of the first UE.

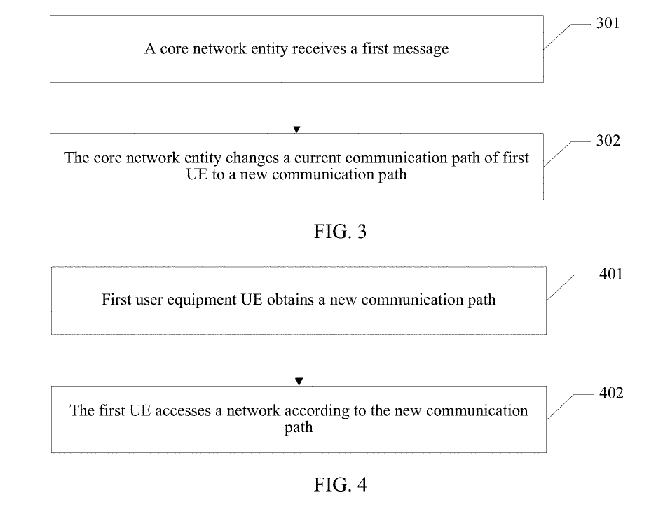

Based on the embodiments shown in FIG. 1 and FIG. 2, referring to FIG. 3, an embodiment of a method for accessing a network in an embodiment of the present disclosure, which is an embodiment of a method for accessing a network on a core network entity side, includes receiving, by a core network entity, a first message, where the first message is used to request the core network entity to change a current communication path of the first UE, and changing, by the core network entity, the current communication path of the first UE to a new communication path such that the first UE accesses a network using the new communication path.

A specific process is as follows.

Step 301: The core network entity receives the first message.

The first message is a path change request message.

Step 302: The core network entity changes the current communication path of the first UE to the new communication path.

The core network entity learns, according to the first message, that the first UE requests to change the current communication path, and the core network entity changes, using an indication of the first message, the current communication path of the first UE to the new communication path such that the first UE accesses a network using the new communication path.

In some optional embodiments, receiving, by a core network entity, a first message includes receiving, by the core network entity, the first message sent by the second UE, where the first message includes an identity of the first UE.

In some other optional embodiments, receiving, by a core network entity, a first message includes receiving, by the core network entity, the first message that is sent by the first UE using the second UE, where the first message includes an identity of the first UE and an ECGI of a target cell that is detected by the first UE.

The target cell is a cell that is detected by the first UE and that has maximum signal strength. Optionally, the first UE sorts, in descending order of strength, signals that are detected, and selects a cell having a strongest signal as the target cell.

Further, in some optional embodiments, changing, by the core network entity, a current communication path of the first UE to a new communication path includes sending, by the core network entity, a second message to a first base station such that the first base station generates a target to source transparent container, and sends the target to source transparent container to the core network entity using a third message, where the first base station is a base station serving the second UE, where the second message may be a handover request message, the third message may be a handover request acknowledgement (ACK) message, and certainly, the second message and the third message may also be replaced by another message representing a same function, and this is not limited herein, and changing, by the core network entity, the current communication path of the first UE to the new communication path according to the target to source transparent container.

It should be noted that the target to source transparent container includes a resource that is allocated by the first base station to the first UE and that is used to access the first base station. The resource includes a PCI of a target cell to be accessed by the first UE, information about an access frequency, a random access code, information about a data radio bearer, or the like. The resource may be included in an RRC reconfiguration message generated by the first base station. The target cell belongs to the first base station. The core network entity sends the target to source transparent container to the second UE such that the second UE sends the target to source transparent container to the first UE, and the first UE accesses the first base station according to the target to source transparent container in order to set up the new communication path. The first UE may further access the first base station according to the RRC reconfiguration message included in the target to source transparent container.

In some other optional embodiments, changing, by the core network entity, a current communication path of the first UE to a new communication path includes obtaining, by the core network entity, a second base station, where the second base station is a base station corresponding to the ECGI, sending, by the core network entity, a fourth message to the first base station such that the first base station sends a fifth message to the core network entity, where the fourth message may be a handover resource request message, the fifth message may be a handover resource request ACK message, and certainly, the fourth message and the fifth message may also be replaced by another message representing a same function, and this is not limited herein, sending, by the core network entity, a second message to the second base station such that the second base station generates a target to source transparent container, and sends the target to source transparent container to the core network entity using a third message, and changing, by the core network entity, the current communication path of the first UE to the new communication path according to the target to source transparent container.

It should be noted that the core network entity sends the target to source transparent container to the first UE using the second UE such that the first UE accesses the second base station according to the target to source transparent container in order to set up the new communication path.

Further, the sending, by the core network entity, a second message to a first base station such that the first base station generates a target to source transparent container includes obtaining, by the core network entity, a first evolved packet system bearer identity EBI, where the first EBI is an EBI of the first UE, obtaining, by the core network entity, a second EBI of the second UE according to the first EBI of the first UE, and adding, by the core network entity, the second EBI to the second message such that the first base station generates the target to source transparent container according to the second EBI.

Further, sending, by the core network entity, a second message to the second base station such that the second base station generates a target to source transparent container includes obtaining, by the core network entity, a first EBI, where the first EBI is an EBI of the first UE, obtaining, by the core network entity, a second EBI of the second UE according to the first EBI of the first UE, adding, by the core network entity, the second EBI to the fourth message such that the first base station generates a source to target transparent container according to the second EBI, and sends the source to target transparent container to the core network entity using the fifth message, where the source to target transparent container includes a resource of a cell in which the second UE is currently located, and the resource includes a PCI of the cell in which the second UE is currently located, information about an access frequency, a random access code, information about a data radio bearer corresponding to the second EBI, or the like, and the cell in which the second UE is currently located belongs to the first base station, and adding, by the core network entity, the source to target transparent container to the second message such that the second base station generates the target to source transparent container according to the source to target transparent container.

In this embodiment, only a case in which the first base station and the second base station are different is listed, for a case in which the core network entity determines, according to an ECGI, that the first base station and the second base station are the same, processing may be performed according to steps 202 or 302. This is not limited herein.

In some optional embodiments, after changing, by the core network entity, a current communication path of the first UE to a new communication path, the method further includes obtaining, by the core network entity, bearer context of the first UE, where the bearer context of the first UE saves a mapping relationship between the first EBI corresponding to the target bearer of the first UE and the second EBI of the second UE, and obtaining, by the core network entity, the second EBI of the second UE according to the mapping relationship, and sending a sixth message to the first base station such that the first base station sends a seventh message to the second UE to delete a bearer corresponding to the second EBI of the second UE.

The sixth message may be a deactivate bearer request message. The seventh message may be a deactivate bearer response message. Certainly, the sixth message and the seventh message may also be replaced by another message representing a same function. This is not limited herein.

Further, after deleting a bearer corresponding to the second EBI of the second UE, the method further includes deleting, by the core network entity, the mapping relationship between the first EBI of the first UE and the second EBI of the second UE in the bearer context of the first UE.

In this embodiment of the present disclosure, a core network entity receives a first message, where the first message is used to request the core network entity to change a current communication path of the first UE, and the core network entity changes the current communication path of the first UE to a new communication path such that the first UE accesses a network using the new communication path. Communication is not interrupted in order to ensure continuity of a related service of the first UE.

Based on the embodiment shown in FIG. 3, referring to FIG. 4, another embodiment of a method for accessing a network in an embodiment of the present disclosure, which is an embodiment of a method for accessing a network on a UE side, includes obtaining, by first UE, a new communication path, and changing, by a core network entity, a current communication path of the first UE to the new communication path, and accessing, by the first UE, a network according to the new communication path.

A specific process is as follows.

Step 401: The first UE obtains the new communication path.

A core network entity changes a current communication path of the first UE to the new communication path.

In some optional embodiments, before obtaining, by first UE, a new communication path, the method further includes obtaining, by the first UE, network information from the second UE, obtaining, by the first UE according to the network information, an ECGI of a target cell that is detected by the first UE, and sending, by the first UE, a first message to the second UE such that the second UE sends the first message to the core network entity.

Further, the network information includes at least one of a GUTI of the first UE, an access frequency of a cell on which the second UE currently camps, a PCI of a cell on which the second UE currently camps, or an SIB of a cell on which the second UE currently camps.

Step 402: The first UE accesses the network according to the new communication path.

In some optional embodiments, after accessing, by the first UE, a network according to the new communication path, the method further includes modifying, by the first UE, a mapping target of an uplink TFT from a DBI to a first EBI corresponding to the target bearer on the first UE.

Further, after modifying, by the first UE, a mapping target of an uplink TFT from a DBI to a first EBI corresponding to the target bearer on the first UE, the method further includes deleting, by the first UE, a mapping relationship between the DBI and the first EBI.

In this embodiment of the present disclosure, first UE obtains a new communication path, and a core network entity changes a current communication path of the first UE to the new communication path, and the first UE accesses a network according to the new communication path. It can be seen that communication is not interrupted in order to ensure continuity of a related service of the first UE.

Based on the foregoing embodiments, an embodiment of an application scenario of data transmission is further described. In this embodiment, an example in which first UE is a WD and second UE is a terminal is used. Further, a process in which after the WD accesses a network using the terminal, when the WD moves away from the terminal, the WD still has a related service currently, and the WD directly accesses the network by itself is as follows.

Step 501: The WD sends a network information request to the terminal.

The WD accesses a network using the terminal, and is in a connected state in this case. However, the WD detects that a distance between the WD and the terminal is increasing. Consequently, a network signal of the WD becomes poorer, a related service of the WD is affected, and the like. Therefore, the WD sends the network information request to the terminal, and expects to obtain network information from the terminal in order to directly access the network using the obtained network information.

Step 502: The terminal sends a network information response to the WD.

The terminal sends the network information response to the WD such that the WD obtains the network information. The network information includes one of or a combination of multiple of a GUTI of the WD, an access frequency of a cell on which the terminal currently camps, a PCI of a cell on which the terminal currently camps, or an SIB of a cell on which the terminal currently camps. It should be noted that in addition to the several types, content included in the network information may be other content. This is not limited herein.

Step 503: The WD directly accesses a network.

The WD changes from accessing the network using the terminal to directly accessing the network by itself, and the WD directly accesses the network using the network information. Communication is not interrupted in order to ensure continuity of a related service of the WD.

Step 504: The WD sends a TAU message to a core network entity.

The WD sends the TAU message to the core network entity using the terminal, where the TAU message includes the GUTI of the WD and path change indication information.

Step 505: The core network entity obtains bearer context of the WD.

The core network entity learns, according to the TAU message, that the WD already accesses the network by itself and is in a network connected state. The core network entity obtains the bearer context of the WD, and learns that a corresponding target bearer needs to be set up for the WD. The target bearer may be a bearer between the WD and an SGW corresponding to the WD. This is not limited herein.

Optionally, the core network entity determines, according to indication information of the WD, that the WD cannot set up the target bearer by itself, and then the core network entity replaces the WD to set up the target bearer. Certainly, when the WD is capable of setting up the target bearer, the WD may set up the target bearer by itself. This is not limited herein.

Step 506: The core network entity sends a bearer setup request to a base station.

It can be understood that the core network entity expects to obtain, from the base station, a radio resource for setting up the target bearer, and further sets up a radio bearer between the base station and the WD.

Step 507: The WD sets up a radio bearer between the WD and the base station.

The base station sends a radio bearer setup request to the WD, and the WD sends a radio bearer setup response to the base station in order to set up the radio bearer between the WD and the base station.

Step 508: The WD deletes a mapping relationship between a DBI and a first EBI.

A mapping target of an uplink TFT is modified from the DBI to the first EBI corresponding to the target bearer on the WD, and the mapping relationship between the DBI and the first EBI is deleted. The WD locally saves the mapping relationship between the DBI and the first EBI.

Step 509: The base station sends a bearer setup response message to the core network entity.

After the WD deletes the locally saved mapping relationship between the DBI and the first EBI, the base station further sends the bearer setup response message to the core network entity.

Step 510: The core network entity sends a modify bearer request to a first gateway.

The first gateway may be an SGW corresponding to the terminal. This is not limited herein.

Step 511: The first gateway sends a modify bearer response message to the core network entity.

Step 512: The core network entity sends a TAU confirm message to the WD.

The WD receives the TAU confirm message sent by the core network entity in order to set up the target bearer on the WD.

Step 513: The core network entity learns that a mapping relationship between the first EBI and a second EBI needs to be deleted.

Further, the core network entity obtains bearer context of the WD, where the bearer context of the WD saves the mapping relationship between the first EBI corresponding to the target bearer on the WD and the second EBI of the terminal.

Step 514: The core network entity sends a deactivate bearer request to the base station.

When the second UE is in an idle state, the core network entity may make, using a paging process, the second UE in a connected state in order to send the deactivate bearer request to the base station.

Step 515: The base station sends an RRC connection reconfiguration message to the terminal.

The core network entity obtains the second EBI of the terminal according to the mapping relationship, and sends the deactivate bearer request to the base station such that the base station sends the RRC connection reconfiguration message to the terminal to delete a bearer corresponding to the second EBI of the terminal.

Further, the core network entity deletes the mapping relationship between the first EBI of the WD and the second EBI in the bearer context.

Step 516: The terminal learns that the core network entity deletes a bearer corresponding to the second EBI.

The terminal learns, using the RRC connection reconfiguration message sent by the base station, that the core network entity deletes the bearer corresponding to the second EBI.

Step 517: The terminal sends an RRC connection reconfiguration complete message to the base station.

Step 518: The base station sends a deactivate bearer response message to the core network entity.

The terminal sends the RRC connection reconfiguration message to the base station such that the base station sends the deactivate bearer response message to the core network entity, and further, the WD deletes a bearer between the WD and the terminal.

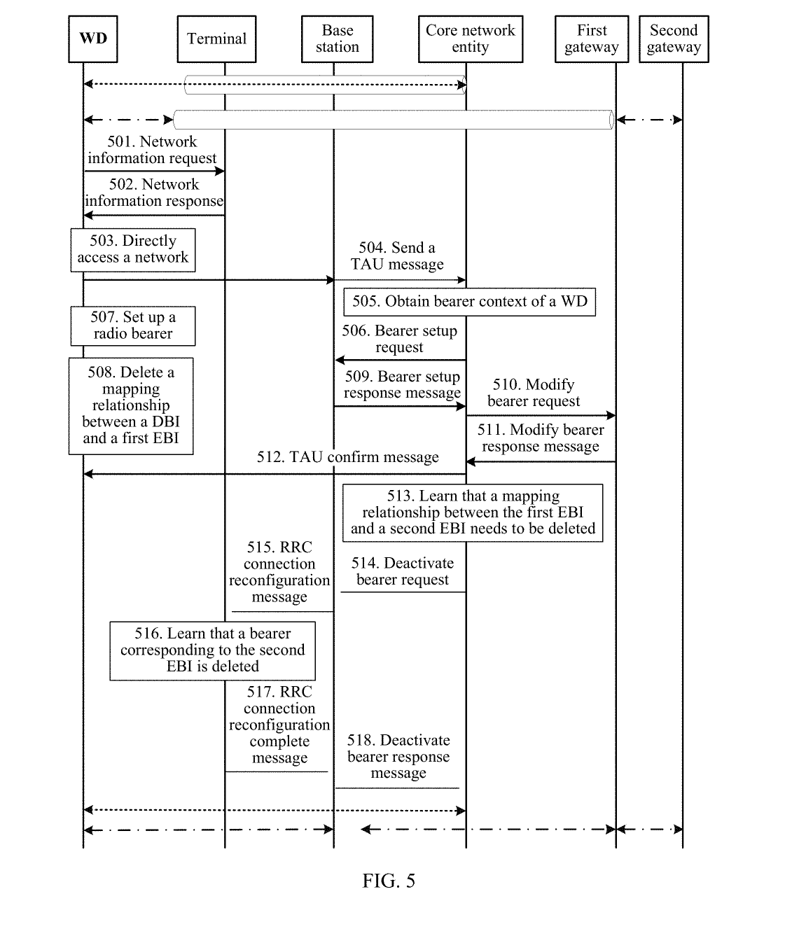

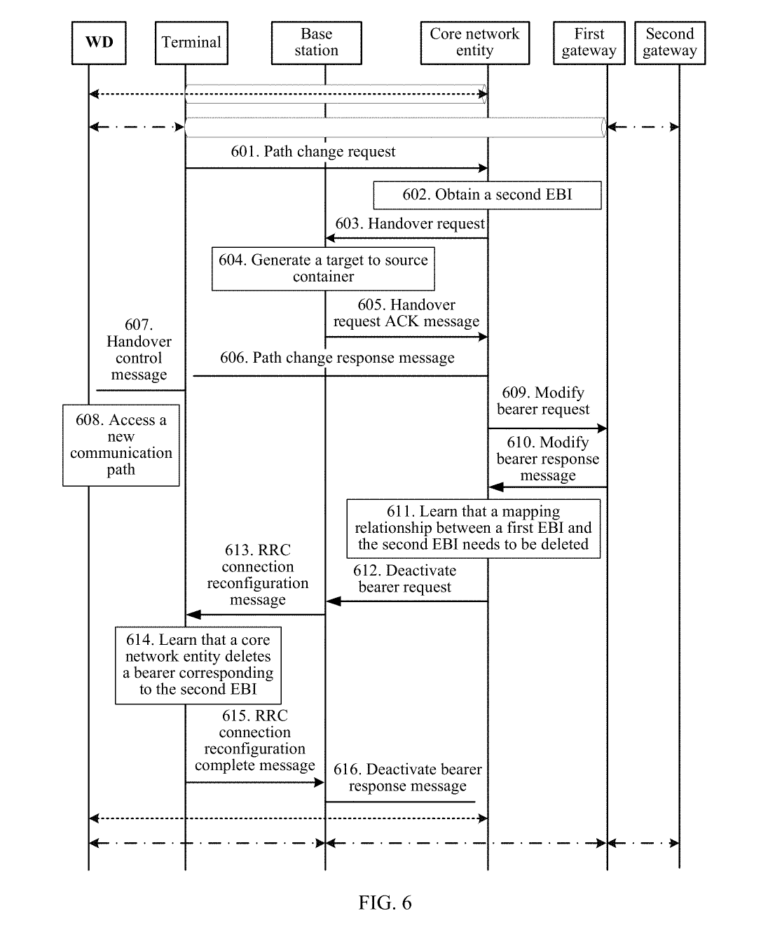

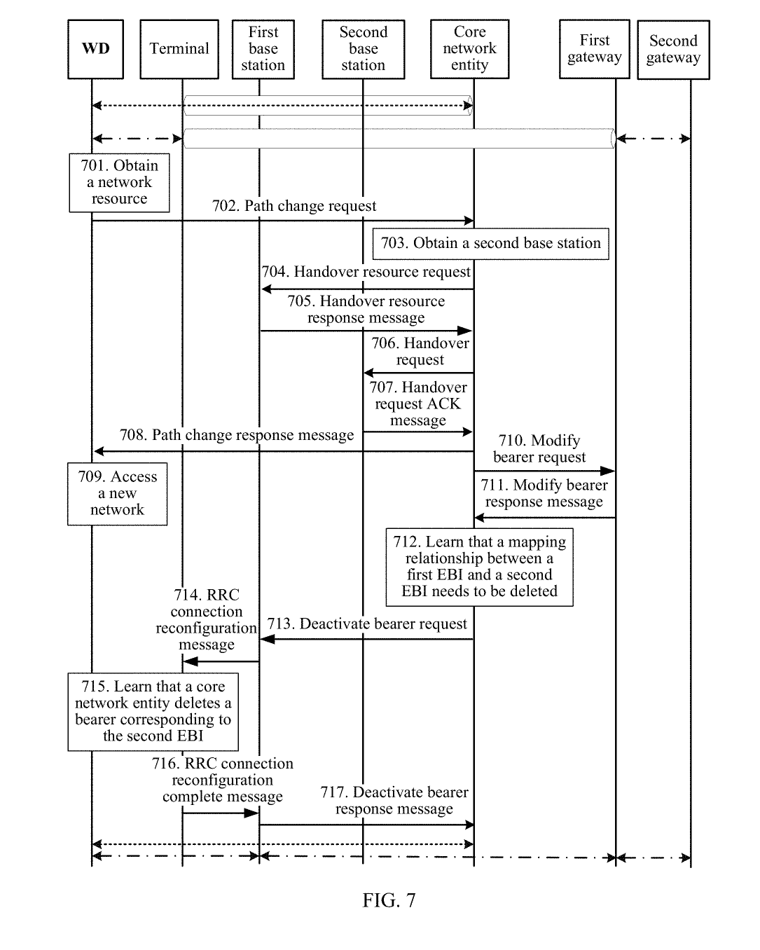

Based on the embodiment shown in FIG. 5, further, referring to FIG. 6, in this embodiment, an example in which first UE is a WD, and second UE is a terminal is used. Further, a process in which after the WD accesses a network using the terminal, when the WD moves away from the terminal, the WD still has a related service currently, and the second UE replaces the first UE to request to change a communication path is as follows.

Step 601: The terminal sends a path change request to a core network entity.

When the terminal detects that signal strength between the terminal and the WD is less than a preset threshold, the terminal sends the path change request to the core network entity, where the path change request includes a GUTI of the WD.

Step 602: The core network entity obtains a second EBI.

The core network entity obtains the second EBI by receiving the path change request sent by the terminal and using a saved mapping relationship between a first EBI and the second EBI.

Step 603: The core network entity sends a handover request to a base station.

The base station is a base station serving the terminal.

Step 604: The base station generates a target to source transparent container.

The base station generates the target to source transparent container according to the received handover request, where the target to source transparent container includes a resource that is allocated by the base station to the WD and that is used to access the base station.

Step 605: The base station sends a handover request ACK message to the core network entity.

Further, the base station sends the handover request ACK message to the core network entity, where the handover request ACK message carries the target to source transparent container.

Step 606: The core network entity sends a path change response message to the terminal.

The core network entity sends the target to source transparent container to the terminal using a change response message.

Step 607: The terminal sends a handover control message to the WD.

The terminal sends the target to source transparent container to the WD using the handover control message.

Step 608: The WD accesses a new communication path.

The WD accesses the new communication path by receiving the target to source transparent container. Communication is not interrupted in order to ensure continuity of a related service of the WD.

Step 609: The core network entity sends a modify bearer request to a first gateway.

Step 610: The first gateway sends a modify bearer response message to the core network entity.

The WD accesses the base station according to a parameter in the target to source transparent container, and the WD sends a handover confirm message to the base station. Further, the base station sends a handover notify message to the core network entity. Further, the core network entity sends the modify bearer request message to the first gateway. The first gateway sends the modify bearer response message to the core network entity. Therefore, a bearer of the WD is set up.

Step 611: The core network entity learns that a mapping relationship between a first EBI and the second EBI needs to be deleted.

Step 612: The core network entity sends a deactivate bearer request to the base station.

Step 613: The base station sends an RRC connection reconfiguration message to the terminal.

Step 614: The terminal learns that the core network entity deletes a bearer corresponding to the second EBI.

Step 615: The terminal sends an RRC connection reconfiguration complete message to the base station.

Step 616: The base station sends a deactivate bearer response message to the core network entity.

Step 611 to step 616 are the same as or similar to step 513 to step 518 in the embodiment shown in FIG. 5. Further, refer to step 513 to step 518, and details are not described herein again.

Based on the embodiment shown in FIG. 6, referring to FIG. 7, in this embodiment, an example in which first UE is a WD, and second UE is a terminal is used. Further, a process in which after the WD accesses a network using the terminal, when the WD moves away from the terminal, the WD still has a related service currently, and the first UE requests to change a communication path is as follows.

Step 701: The WD obtains network information from the terminal.

The WD may send a network information request to the terminal such that the terminal sends a network information response message to the WD, and the WD obtains the network information from the terminal.

The network information may be one of or a combination of several of a GUTI of the WD, an access frequency of a cell on which the terminal currently camps, a PCI of a cell on which the terminal currently camps, or an SIB of a cell on which the terminal currently camps, or may include other content. This is not limited herein.

Step 702: The WD sends a path change request to a core network entity.

The WD sends the path change request to the core network entity using the terminal. The path change request includes the GUTI of the WD and an ECGI.

It should be noted that the WD sends a special non-access stratum (NAS) message to the terminal using an interface PC5. The terminal encapsulates the NAS message and sends the NAS message to the core network entity. The special NAS message may include reusing an existing NAS message or a newly defined NAS message. For example, reusing an existing message may include reusing existing uplink generic NAS transport. Content of a generic message container is indicated, using a newly defined generic message container type generic message container type, as the NAS message of the first UE.

Step 703: The core network entity obtains a second base station.

The second base station is a base station corresponding to the ECGI.

Step 704: The core network entity sends a handover resource request to a first base station.

Step 705: The first base station sends a handover resource response message to the core network entity.

The core network entity sends the handover resource request to the first base station, and expects to obtain a new resource from the first base station. Then, the first base station sends the handover resource response message to the core network entity such that the core network entity obtains a new radio resource.

Step 706: The core network entity sends a handover request to the second base station.

The second base station generates a target to source transparent container according to the handover request.

Step 707: The second base station sends a handover request ACK message to the core network entity.

The handover request ACK message includes the target to source transparent container generated by the second base station.

Step 708: The core network entity sends a path change response message to the WD using the terminal.

The core network entity sends the target to source transparent container to the WD using a change response message.

Step 709: The WD accesses a new communication path.

The WD accesses the new communication path using the target to source transparent container. It can be seen that communication is not interrupted in order to ensure continuity of a related service of the WD.

Step 710: The core network entity sends a modify bearer request to a first gateway.

Step 711: The first gateway sends a modify bearer response message to the core network entity.

The WD accesses the base station according to a parameter in the target to source transparent container, and the WD sends a handover confirm message to the second base station. Further, the second base station sends a handover notify message to the core network entity. Further, the core network entity sends the modify bearer request message to the first gateway. The first gateway sends the modify bearer response message to the core network entity. Therefore, a bearer of the WD is set up.

Step 712: The core network entity learns that a mapping relationship between a first EBI and a second EBI needs to be deleted.

Step 713: The core network entity sends a deactivate bearer request to the first base station.

Step 714: The first base station sends an RRC connection reconfiguration message to the terminal.

Step 715: The terminal learns that the core network entity deletes a bearer corresponding to the second EBI.

Step 716: The terminal sends an RRC connection reconfiguration complete message to the first base station.

Step 717: The first base station sends a deactivate bearer response message to the core network entity.

Step 712 to step 717 are the same as or similar to step 513 to step 518 in the embodiment shown in FIG. 5. Further, refer to step 513 to step 518, and details are not described herein again.

In this embodiment, only a case in which the first base station and the second base station are different is listed, for a case in which the core network entity determines, according to an ECGI, that the first base station and the second base station are the same, processing may be performed according to the solution in this embodiment or according to step 602 to step 616. This is not limited herein.

For better implementing the foregoing related method in the embodiments of the present disclosure, the following further provides a related apparatus configured to coordinate with the foregoing method.

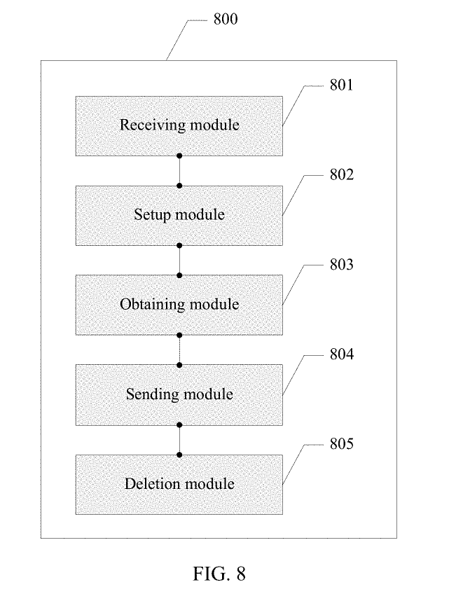

Referring to FIG. 8, an embodiment of a data transmission apparatus 800 in an embodiment of the present disclosure includes a receiving module 801 and a setup module 802.

The receiving module 801 is configured to receive a first message sent by first UE, where the first message is used by the first UE to request to change from accessing a network using second UE to directly accessing the network.

The setup module 802 is configured to set up a target bearer on the first UE such that the first UE transmits data using the target bearer.

In some optional embodiments, the setup module 802 is further configured to obtain bearer context of the first UE, and set up the target bearer on the first UE according to the bearer context of the first UE.

In some optional embodiments, the setup module 802 is further configured to send a second message to a base station such that the base station sends a third message to the first UE, and sends a fourth message to the core network entity, and receive the fourth message in order to set up a bearer between the first UE and a gateway.

In some optional embodiments, the data transmission apparatus 800 further includes an obtaining module 803 configured to obtain the bearer context of the first UE, where the bearer context of the first UE saves a mapping relationship between a first EBI corresponding to the target bearer on the first UE and a second EBI of the second UE, where the obtaining module 803 is further configured to obtain the second EBI of the second UE according to the mapping relationship, and a sending module 804 configured to send a fifth message to the base station such that the base station sends a sixth message to the second UE to delete a bearer corresponding to the second EBI of the second UE.

In some optional embodiments, the data transmission apparatus 800 further includes a deletion module 805 configured to delete the mapping relationship between the first EBI and the second EBI in the bearer context of the first UE.

The first message above includes path change indication information.

Optionally, the first message is a TAU message.

In this embodiment of the present disclosure, the receiving module 801 receives a first message sent by first UE, where the first message is used by the first UE to request to change from accessing a network using second UE to directly accessing the network, and the setup module 802 sets up a target bearer on the first UE such that the first UE transmits data using the target bearer. Communication is not interrupted in order to ensure continuity of a related service of the first UE.

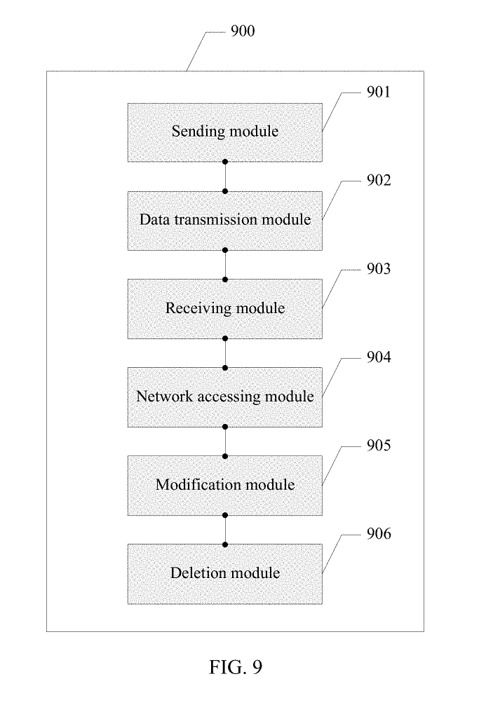

Based on the embodiment shown in FIG. 8, referring to FIG. 9, an embodiment of a data transmission apparatus 900 in an embodiment of the present disclosure includes a sending module 901 and a data transmission module 902.

The sending module 901 is configured to send a first message to a core network entity such that the core network entity sets up a target bearer on the first UE, where the first message is used by the first UE to request to change from accessing a network using second UE to directly accessing the network.

The data transmission module 902 is configured to transmit data using the target bearer.

In some optional embodiments, the data transmission apparatus 900 further includes the sending module 901, further configured to send a seventh message to the second UE before sending the first message to the core network entity, where the seventh message is used to request the second UE to send network information to the first UE, a receiving module 903 configured to receive the network information sent by the second UE, and a network accessing module 904 configured to access the network using the network information.

Further, the network information includes at least one of a GUTI of the first UE, an access frequency of a cell on which the second UE currently camps, a PCI of a cell on which the second UE currently camps, or an SIB of a cell on which the second UE currently camps.

In some optional embodiments, the data transmission apparatus 900 further includes a modification module 905 configured to modify a mapping target of an uplink TFT from a DBI to a first EBI corresponding to the target bearer on the first UE before the data transmission module 902 transmits the data using the target bearer.

In some optional embodiments, the data transmission apparatus 900 further includes a deletion module 906 configured to delete a mapping relationship between the DBI and the first EBI after the mapping target of the uplink TFT is modified from the DBI to the first EBI corresponding to the target bearer on the first UE.

Further, the first message includes path change indication information.

Optionally, the first message is a TAU message.

In this embodiment of the present disclosure, the sending module 901 sends a first message to a core network entity such that the core network entity sets up a target bearer on the first UE, where the first message is used by the first UE to request to change from accessing a network using second UE to directly accessing the network, and the data transmission module 902 transmits data using the target bearer. Communication is not interrupted in order to ensure continuity of a related service of the first UE.

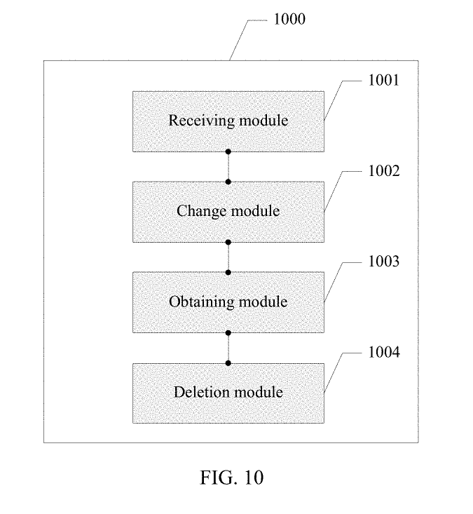

Based on the embodiments shown in FIG. 8 and FIG. 9, referring to FIG. 10, an embodiment of an apparatus 1000 for accessing a network in an embodiment of the present disclosure includes a receiving module 1001 and a change module 1002.

The receiving module 1001 is configured to receive a first message, where the first message is used to request a core network entity to change a current communication path of the first UE.

The change module 1002 is configured to change the current communication path of the first UE to a new communication path such that the first UE accesses a network using the new communication path.

In some optional embodiments, the receiving module 1001 is further configured to receive the first message sent by the second UE, where the first message includes an identity of the first UE.

In some optional embodiments, the receiving module 1001 is further configured to receive the first message that is sent by the first UE using the second UE, where the first message includes an identity of the first UE and an ECGI of a target cell that is detected by the first UE.

In some optional embodiments, the change module 1002 is further configured to send a second message to a first base station such that the first base station generates a target to source transparent container, and sends the target to source transparent container to the core network entity using a third message, where the first base station is a base station serving the second UE, and change the current communication path of the first UE to the new communication path according to the target to source transparent container.

In some optional embodiments, the change module 1002 is further configured to obtain a second base station, where the second base station is a base station corresponding to the ECGI, send a fourth message to the first base station such that the first base station sends a fifth message to the core network entity, send a second message to the second base station such that the second base station generates a target to source transparent container, and sends the target to source transparent container to the core network entity using a third message, and change the current communication path of the first UE to the new communication path according to the target to source transparent container.

In some optional embodiments, the change module 1002 is further configured to obtain a first evolved packet system bearer identity EBI, where the first EBI is an EBI of the first UE, obtain a second EBI of the second UE according to the first EBI of the first UE, and add the second EBI to the second message such that the first base station generates the target to source transparent container according to the second EBI.

In some optional embodiments, the change module 1002 is further configured to obtain a first EBI, where the first EBI is an EBI of the first UE, obtain a second EBI of the second UE according to the first EBI of the first UE, add the second EBI to the fourth message such that the first base station generates a source to target transparent container according to the second EBI, and sends the source to target transparent container to the core network entity using the fifth message, and add the source to target transparent container to the second message such that the second base station generates the target to source transparent container according to the source to target transparent container.

In some optional embodiments, the apparatus 1000 further includes an obtaining module 1003 configured to obtain bearer context of the first UE after the change module 1002 changes the current communication path of the first UE to the new communication path, where the bearer context of the first UE saves a mapping relationship between the first EBI corresponding to the target bearer of the first UE and the second EBI of the second UE, where the obtaining module 1003 is further configured to obtain the second EBI of the second UE according to the mapping relationship, and send a sixth message to the first base station such that the first base station sends a seventh message to the second UE, to delete a bearer corresponding to the second EBI of the second UE.

In some optional embodiments, the apparatus 1000 further includes a deletion module 1004 configured to delete the mapping relationship between the first EBI of the first UE and the second EBI of the second UE in the bearer context of the first UE.

In this embodiment of the present disclosure, the receiving module 1001 receives a first message, where the first message is used to request the core network entity to change a current communication path of the first UE, and the change module 1002 changes the current communication path of the first UE to a new communication path such that the first UE accesses a network using the new communication path. Communication is not interrupted in order to ensure continuity of a related service of the first UE.

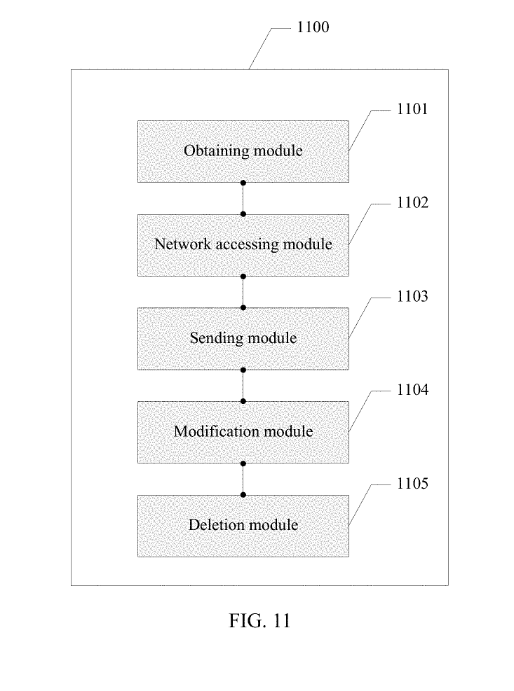

Based on the embodiment shown in FIG. 10, referring to FIG. 11, an embodiment of an apparatus 1100 for accessing a network in an embodiment of the present disclosure includes an obtaining module 1101 and a network accessing module 1102.

The obtaining module 1101 is configured to obtain a new communication path, where a core network entity changes a current communication path of the first UE to the new communication path.

The network accessing module 1102 is configured to access a network according to the new communication path.

In some optional embodiments, the apparatus 1100 further includes the obtaining module 1101, further configured to obtain network information from the second UE, the obtaining module 1101, further configured to obtain, according to the network information, an ECGI of a target cell that is detected by the first UE, and a sending module 1103 configured to send a first message to the second UE such that the second UE sends the first message to the core network entity.

Further, the network information includes at least one of a GUTI of the first UE, an access frequency of a cell on which the second UE currently camps, a PCI of a cell on which the second UE currently camps, or an SIB of a cell on which the second UE currently camps.

In some optional embodiments, the apparatus 1100 further includes a modification module 1104 configured to after the network accessing module 1102 accesses the network according to the new communication path, modify a mapping target of an uplink TFT from a DBI to a first EBI corresponding to the target bearer on the first UE.

In some optional embodiments, the apparatus 1100 further includes a deletion module 1105 configured to after the modification module 1104 modifies the mapping target of the uplink TFT from the DBI to the first EBI corresponding to the target bearer on the first UE, delete, by the first UE, a mapping relationship between the DBI and the first EBI.

In this embodiment of the present disclosure, the obtaining module 1101 obtains a new communication path, and a core network entity changes a current communication path of the first UE to the new communication path, and the network accessing module 1102 accesses a network according to the new communication path. It can be seen that communication is not interrupted in order to ensure continuity of a related service of the first UE.

In the foregoing embodiments, the description of each embodiment has respective focuses. For a part that is not described in detail in an embodiment, refer to related descriptions in other embodiments.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be saved in a computer-readable storage medium. Based on such an understanding, the technical solutions of the present disclosure essentially, or the part contributing to other approaches, or all or some of the technical solutions may be implemented in the form of a software product. The computer software product is saved in a storage medium and includes several instructions for instructing a computer device (which may be a personal computer, a server, or a network device) to perform all or some of the steps of the methods described in the embodiments of the present disclosure. The foregoing storage medium includes any medium that can save program code, such as a universal serial bus (USB) flash drive, a removable hard disk, a read-only memory (ROM), a random access memory (RAM), a magnetic disk, or an optical disc.

The data transmission method and the related device provided in the present disclosure are described in detail above. The principle and implementations of the present disclosure are described herein using specific examples. The descriptions about the embodiments are merely provided to help understand the method and core ideas of the present disclosure. In addition, a person of ordinary skill in the art can make variations and modifications to the present disclosure in terms of the specific implementations and application scopes according to the ideas of the present disclosure. Therefore, the content of the specification shall not be construed as a limit to the present disclosure.

1.-7. (canceled)

8. A data transmission method, comprising:
sending, by a first user equipment (UE), a first message to a core network entity, wherein the first message is used by the first UE to request to change from accessing a network using a second UE to directly accessing the network; and
transmitting, by the first UE, data using a target bearer.

9. The method according to claim 8, wherein before sending the first message, the method further comprises:
sending, by the first UE, a second message to the second UE, wherein the second message requests network information;
receiving, by the first UR the network information from the second LIE; and
accessing, by the first UE, the network using the network information.

10. The method according to claim 9, wherein the network information comprises at least one of:
a globally unique temporary UE identity (GUTI) of the first UE;
an access frequency of a cell on which the second UE currently camps;
a physical cell identity of the cell on which the second UE currently camps; or
a system information block (SIB) of the cell on which the second UE currently camps.

11. The method according to claim 8, wherein before transmitting the data the target bearer, the method further comprises modifying, by the first UE, a mapping target of an uplink traffic flow template (TFT) from a device to device bearer identity (DBI) to a first evolved packet system (EPS) bearer identity (EBI) corresponding to the target bearer on the first UE.

12. The method according to claim 11, wherein after modifying the mapping target of the uplink TFT, the method further comprises deleting, by the first UE, a mapping relationship between the DBI and the first EBI.

13. The method according to claim 8, wherein the first message comprises path change indication information.

14. The method according to claim 8, wherein the first message comprises a tracking area update (TAU) message.

15.-23. (canceled)

24. A method for accessing a network, comprising:
obtaining, by first user equipment (UE), a new communication path;
changing, by a core network entity, a current communication path of the first UE to the new communication path; and
accessing, by the first UE, the network according to the new communication path.

25. The method according to claim 24, wherein before obtaining the new communication path, the method further comprises:
obtaining, by the first UE network information from second UE;
obtaining, by the first UE according to the network information, an evolved universal mobile telecommunications system (UMTS) terrestrial radio access network (E-UTRAN) cell global identifier (ECGI) of a target cell; and
sending, by the first UE, a first message to the second UE.

26. The method according to claim 25, wherein the network information comprises at least one of:
a globally unique temporary UE identity (GUTI) of the first UE;
an access frequency of a cell on which the second UE currently camps;
a physical cell identity of the cell on which the second UE currently camps; or
a system information block (SIB) of the cell on which the second UE currently camps.

27. The method according to claim 24, wherein after accessing the network, the method further comprises modifying, by the first UE, a mapping target of an uplink traffic flow template (TFT) from a device to device bearer identity (DBI) to a first evolved packet system (EPS) bearer identity (EBI) corresponding to a target bearer on the first UE.

28. The method according to claim 27, wherein after a modifying the mapping target of the uplink TFT, the method further comprises deleting, by the first UE, a mapping relationship between the DBI and the first EBI.

29.-56. (canceled)

57. A mobile terminal, comprising:
a memory configured to store a program;
a channel interface coupled to the memory; and
a processor coupled to the memory and the channel interface, wherein the program causes the processor to be configured to:
send, using the channel interface, a first message to a core network entity, wherein the first message is used by the mobile terminal to request to change from accessing a network using second user equipment (UE) to directly accessing the network; and
transmit, using the channel interface, data using a target bearer.

58. The mobile terminal according to claim 57, wherein before sending the first message to the core network entity, the program further causes the processor to be configured to:
send, using the channel interface, a second message to the second UE, wherein the second message requests the second UE to send network information to the mobile terminal;
receive, using the channel interface, the network information from the second UE; and
access, using the channel interface, the network using the network information.

59. The mobile terminal according to claim 58, wherein the network information comprises at least one of:
a globally unique temporary UE identity (GUTI) of the mobile terminal;
an access frequency of a cell on which the second UE currently camps;
a physical cell identity of the cell on which the second UE currently camps; or
a system information block (SIB) of the cell on which the second UE currently camps.

60. The mobile terminal according to claim 57, wherein before transmitting the data using the target bearer, the program further causes the processor to be configured to modify a mapping target of an uplink traffic flow template (TFT) from a device to device bearer identity (DBI) to a first evolved packet system (EPS) bearer identity (EBI) corresponding to the target bearer on the mobile terminal.

61. The mobile terminal according to claim 60, wherein after modifying the mapping target of the uplink TFT, the program further causes the processor to be configured to delete a mapping relationship between the DBI and the first EBI.

62. The mobile terminal according to claim 57, wherein the first message comprises path change indication information.

63. The mobile terminal according to claim 58, wherein the first message comprises path change indication information.

64. The mobile terminal according to claim 57, wherein the first message comprises a tracking area update (TAU) message.
